(19) United States
(12) Patent Application Publication
(10) Pub. No.: US 2026/0245934 A1
(43) Pub. Date: Aug. 20, 2026

(54) CONTROL DEVICE, FUEL CELL SYSTEM, AND CONTROL METHOD

(71) Applicant: HONDA MOTOR CO., LTD., TOKYO (JP)

(72) Inventor: Shuto MANIWA, WAKO-SHI (JP)

(21) Appl. No.: 19/539,498

(22) Filed: Feb. 13, 2026

(30) Foreign Application Priority Data
Feb. 20, 2025 (JP) 2025-025796

(51) Int. Cl. H01M 8/04746; H01M 8/04014; H01M 8/04828

(52) U.S. Cl. CPC H01M 8/04753; H01M 8/04014; H01M 8/04835

(57) ABSTRACT

A control device for a fuel cell system including a fuel cell unit, a humidifier that humidifies cathode gas supplied to the fuel cell unit, and a temperature adjustment device that adjusts the temperature of the fuel cell unit, includes: an estimation unit that derives an estimated deterioration rate of the fuel cell unit, based on a temperature of the cathode gas introduced into the humidifier; and a temperature control unit that controls the temperature adjustment device to lower the temperature of the fuel cell unit when the estimated deterioration rate is higher than a target deterioration rate of the fuel cell unit.

### CROSS-REFERENCE TO RELATED APPLICATIONS

This application is based upon and claims the benefit of priority from Japanese Patent Application No. 2025-025796 filed on Feb. 20, 2025, the contents of which are incorporated herein by reference.

### BACKGROUND OF THE INVENTION

### Field of the Invention

The present disclosure relates to a control device, a fuel cell system, and a control method.

### Description of the Related Art

In recent years, research and development have been conducted on fuel cells that contribute to energy efficiency in order to ensure that more people have access to affordable, reliable, sustainable and modern energy. For example, JP 2010-129278 A discloses a technique relating to a fuel cell system.

### SUMMARY OF THE INVENTION

In recent years, an improved technique has been desired for suppressing deterioration of a fuel cell.

The present disclosure has the object of satisfying the aforementioned need.

A first aspect of the present disclosure is a control device for a fuel cell system, wherein the fuel cell system includes: a fuel cell unit, a humidifier that humidifies a cathode gas supplied to the fuel cell unit, and a temperature adjustment device that adjusts a temperature of the fuel cell unit. The control device includes: an estimation unit configured to derive an estimated deterioration rate of the fuel cell unit, based on a temperature of the cathode gas introduced into the fuel cell unit; and a temperature control unit configured to, in a case that the estimated deterioration rate is higher than a target deterioration rate of the fuel cell unit, control the temperature adjustment device to lower the temperature of the fuel cell unit.

A second aspect of the present disclosure is a fuel cell system including the control device according to the first aspect of the present disclosure, the fuel cell unit, the humidifier, and the temperature adjustment device.

A third aspect of the present disclosure is a control method of a fuel cell system, wherein the fuel cell system includes: a fuel cell unit; a humidifier that humidifies a cathode gas supplied to the fuel cell unit; and a temperature adjustment device that adjusts a temperature of the fuel cell unit, the control method including: an estimation step of deriving an estimated deterioration rate of the fuel cell unit, based on a temperature of the cathode gas introduced into the fuel cell unit; and a temperature control step of, in a case that the estimated deterioration rate is higher than a target deterioration rate of the fuel cell unit, controlling the temperature adjustment device to lower the temperature of the fuel cell unit.

According to the present disclosure, an improved technique is provided for suppressing deterioration of a fuel cell.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1 is a schematic diagram illustrating a vehicle according to an embodiment of the present disclosure;

FIG. 2 is a configuration diagram of a power generation system shown in FIG. 1;

FIG. 3 is a block diagram showing a configuration of the control device shown in FIG. 1 in more detail;

FIG. 4A is a causal relation diagram showing causal relations between the temperature of cathode gas supplied to a fuel cell unit, the water vapor content of the cathode gas, the temperature of the fuel cell unit, the relative humidity of the cathode gas, and the deterioration rate (estimated deterioration rate) of the fuel cell unit;

FIG. 4B is a diagram simply illustrating a flow of a target cooling temperature determination process performed by a target temperature determination unit;

FIG. 5 is a diagram schematically showing time-series changes of the temperature of the cathode gas, the relative humidity of the cathode gas, the estimated deterioration rate of the fuel cell unit, and the temperature of the fuel cell unit; and

FIG. 6 is a flowchart of a control method according to an embodiment of the present disclosure.

### DETAILED DESCRIPTION OF THE INVENTION

According to JP 2010-129278 A, when the temperature of the fuel cell stack is higher than the temperature of the reactant gas, the fuel cell system reduces the flow rate of the coolant supplied to the fuel cell stack. This increases the temperature and humidity of the reactant gas discharged from the fuel cell stack.

In the technique related to the fuel cell unit, there is a problem to suppress deterioration of the fuel cell. However, the conventional techniques including JP 2010-129278 A cannot necessarily satisfactorily achieve the suppression of deterioration of the fuel cell provided in the fuel cell system. For example, the higher the temperature of the fuel cell, the more likely the water content of the fuel cell (the electrolyte membrane included in the fuel cell) is to decrease. Even when the humidity of the gas discharged from the fuel cell is increased by a process such as reducing the flow rate of the coolant, in a case that the water content of the electrolyte membrane of the fuel cell is excessively insufficient, the deterioration of the electrolyte membrane is eventually accelerated.

With the above preliminary description in mind, an embodiment of the present disclosure will be described below. Note that a program (computer program, computer software) in the following description is also referred to as a computer program product. The computer program product is not limited to a program stored in a storage medium (recording medium), and includes a program transmitted, distributed, or downloaded via a network such as the Internet.

### Embodiments

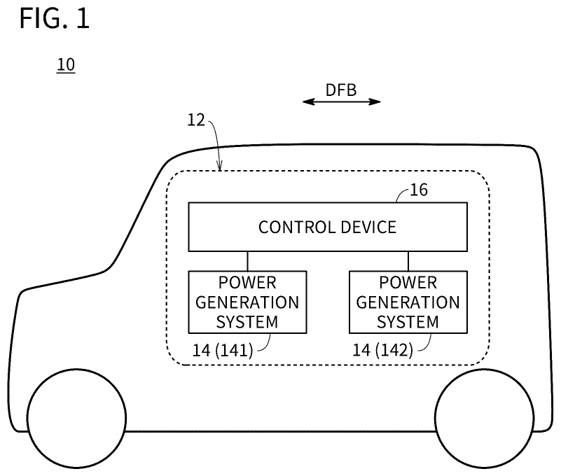

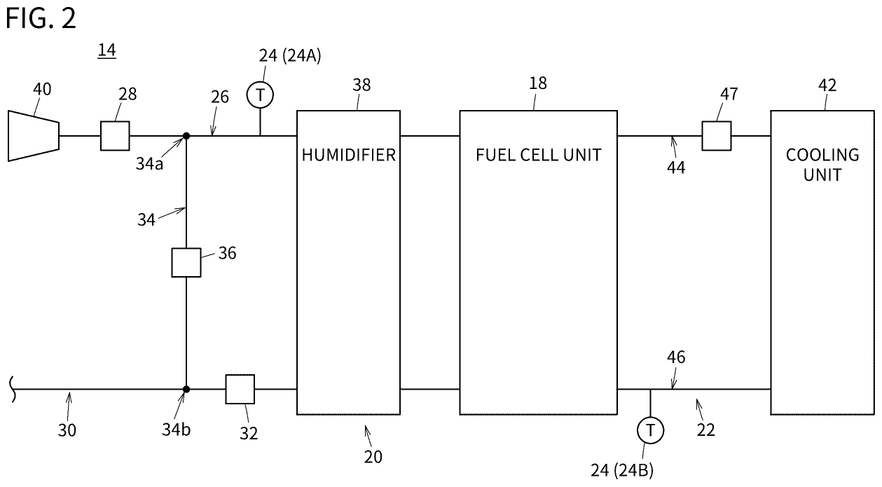

FIG. 1 is a schematic diagram illustrating a vehicle 10 according to an embodiment of the present disclosure. FIG. 2 is a configuration diagram of the power generation system 14 shown in FIG. 1.

The vehicle 10 is, for example, a fuel cell vehicle. The vehicle 10 includes a fuel cell system 12. The fuel cell system 12 includes a plurality of power generation systems 14 and a control device 16. In the present embodiment, a case where the number of the power generation systems 14 is two will be described, but the fuel cell system 12 may have three or more power generation systems 14. The plurality of power generation systems 14 may be arranged in the front-rear direction DFB of the vehicle 10. The plurality of power generation systems 14 may have a common configuration (FIG. 2).

As shown in FIG. 2, the power generation system 14 (each of the plurality of power generation systems 14) includes a fuel cell unit 18, a cathode gas circuit 20, a temperature adjustment device 22, and a plurality of temperature sensors 24.

The fuel cell unit 18 includes a fuel cell. The fuel cell unit 18 may include a plurality of fuel cells. For example, the fuel cell unit 18 may be a fuel cell stack. A fuel cell is a device that generates electrical energy by causing a chemical reaction between oxygen contained in a cathode gas and hydrogen contained in an anode gas. The cathode gas is, for example, air. The anode gas is, for example, hydrogen gas. Although not shown, the fuel cell includes a cathode (cathode electrode portion) to which the cathode gas is supplied, an anode (anode electrode portion) to which the anode gas is supplied, and an electrolyte membrane disposed between the cathode and the anode. The electrolyte membrane is, for example, a solid polymer electrolyte membrane.

The cathode gas circuit 20 is a fluid circuit that supplies the cathode gas to the fuel cell unit 18 and collects, from the fuel cell unit 18, a cathode off-gas discharged from the fuel cell unit 18. The cathode gas circuit 20 includes a gas supply path 26, an air pump unit 28, a gas discharge path 30, a pressure regulating valve unit 32, a bypass path 34, a bypass valve unit 36, and a humidifier 38.

The gas supply path 26 is a first gas flow path connected to the fuel cell unit 18. The cathode gas is supplied to the fuel cell unit 18 through the gas supply path 26. As described above, the cathode gas may be air. In this case, air is taken into the vehicle 10 from the atmosphere via, for example, an air supply port 40 provided in the vehicle 10. In this case, the vehicle 10 may include a plurality of air supply ports 40 corresponding respectively to the plurality of power generation systems 14. The air taken into the vehicle 10 is supplied to the fuel cell unit 18 via the gas supply path 26.

The air pump unit 28 is provided in the gas supply path 26. The air pump unit 28 includes a device that promotes the flow of the cathode gas in the gas supply path 26. For example, the air pump unit 28 includes an air pump that sends air toward the fuel cell unit 18.

The gas discharge path 30 is a second gas flow path connected to the fuel cell unit 18. The cathode off-gas discharged from the fuel cell unit 18 flows into the gas discharge path 30.

The pressure regulating valve unit 32 is provided in the gas discharge path 30. The pressure regulating valve unit 32 includes a valve that regulates the gas flow pressure (gas flow rate). The internal pressure of the fuel cell unit 18 is adjusted by adjusting the gas flow pressure in the gas discharge path 30.

The bypass path 34 is a third gas flow path that connects the gas supply path 26 and the gas discharge path 30. A part of the cathode gas taken in from the air supply port 40 can flow into the gas discharge path 30 through the bypass path 34. As shown in FIG. 2, a bypass inflow portion 34a, which is a connecting portion between the gas supply path 26 and the bypass path 34, may be located between the air pump unit 28 and the fuel cell unit 18. The pressure regulating valve unit 32 may be located between the fuel cell unit 18 and a bypass flow branch portion 34b, which is a connecting portion between the gas discharge path 30 and the bypass path 34.

The bypass valve unit 36 is provided in the bypass path 34. The bypass valve unit 36 includes a valve that adjusts the gas flow pressure (gas flow rate) in the gas discharge path 30.

The humidifier 38 is a device that humidifies the cathode gas. As shown in FIG. 2, the humidifier 38 is disposed between the fuel cell unit 18 and the bypass path 34, and is connected not only to the gas supply path 26 but also to the gas discharge path 30. In this case, the humidifier 38 humidifies the cathode gas by, for example, transferring water content contained in the cathode off-gas to the cathode gas.

The temperature adjustment device 22 is a device for adjusting the temperature Tfc of the fuel cell unit 18 using a coolant. The temperature adjustment device 22 includes a cooling unit 42, a coolant supply path 44, a coolant collection path 46, and a coolant pump unit 47.

The cooling unit 42 is a device that adjusts the temperature of the coolant. For example, a cooling device such as a radiator that cools the coolant is included in the cooling unit 42. The cooling unit 42 that adjusts the temperature of the coolant can substantially adjust the temperature Tfc of the fuel cell unit 18 (electrolyte membrane).

Each of the coolant supply path 44 and the coolant collection path 46 is a flow path for the coolant that connects the fuel cell unit 18 and the cooling unit 42. The coolant cooled by the cooling unit 42 is supplied to the fuel cell unit 18 via the coolant supply path 44. The coolant supplied to the fuel cell unit 18 collects heat from the fuel cell unit 18 (electrolyte membrane), and then returns to the cooling unit 42 via the coolant collection path 46. The coolant that has returned to the cooling unit 42 is cooled by the cooling unit 42, and then supplied again to the fuel cell unit 18 via the coolant supply path 44.

The coolant pump unit 47 includes a device that adjusts the flow rate (flow velocity) of the coolant between the fuel cell unit 18 and the cooling unit 42. For example, a water pump may be included in the coolant pump unit 47. The coolant pump unit 47 is disposed in the coolant supply path 44 (FIG. 2), for example, but may be disposed in the coolant collection path 46.

The plurality of temperature sensors 24 include a gas temperature sensor 24A and a FC temperature sensor 24B.

The gas temperature sensor 24A is a temperature sensor (first temperature sensor) 24 provided in the gas supply path 26. For example, as shown in FIG. 2, the gas temperature sensor 24A is disposed between the bypass inflow portion 34a and the humidifier 38. The gas temperature sensor 24A outputs a detection signal corresponding to the temperature Tcg of the cathode gas introduced into the fuel cell unit 18.

The FC temperature sensor 24B is a temperature sensor (second temperature sensor) 24 that outputs a detection signal corresponding to the temperature of the fuel cell unit 18. The FC temperature sensor 24B is disposed in the fuel cell unit 18, but may be disposed in the coolant collection path 46 as shown in FIG. 2. The coolant flowing through the coolant collection path 46 has heat recovered from the fuel cell unit 18. The detection signal outputted from the FC temperature sensor 24B in accordance with the temperature of the coolant having heat recovered from the fuel cell unit 18 is substantially a detection signal corresponding to the temperature of the fuel cell unit 18.

Although not shown, the power generation system 14 may further include a fluid circuit (anode gas circuit) that supplies, to the fuel cell unit 18, the anode gas taken out from a container such as a gas tank. The power generation system 14 may further include a pump that promotes the flow of coolant, an ion exchange resin that removes ions in the coolant, and the like. The power generation system 14 may further include a pressure sensor for detecting the pressure of the cathode gas and a flow rate sensor for detecting the flow rate of the cathode gas.

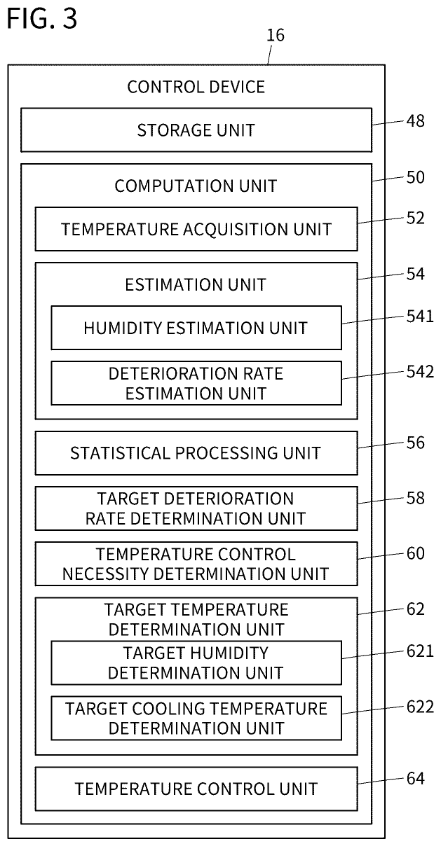

FIG. 3 is a block diagram showing the configuration of the control device 16 shown in FIG. 1 in more detail.

The control device 16 is an electronic device provided in the fuel cell system 12. For example, a computer such as an electronic control unit (ECU) is included in the control device 16. The control device 16 includes a storage unit 48 and a computation unit 50.

The storage unit 48 includes one or more memories. The storage unit 48 includes a nonvolatile memory such as a read only memory (ROM), a flash memory, or a magnetic disk. The nonvolatile memory is a storage medium that non-temporarily stores programs, tables, maps, and the like. At least a part of the storage unit 48 may be realized by a storage medium such as a universal serial bus (USB) memory, a memory card, or an optical disk. The storage unit 48 may include a volatile memory such as a random access memory (RAM).

The computation unit 50 includes processing circuitry capable of executing arithmetic processing. The processing circuitry may include one or more processors. For example, the processing circuit may include a central processing unit (CPU), a graphics processing unit (GPU), or the like. The processing circuit may include an integrated circuit (IC) or a discrete device.

The computation unit 50 includes a temperature acquisition unit 52, an estimation unit 54, a statistical processing unit 56, a target deterioration rate determination unit 58, a temperature control necessity determination unit 60, a target temperature determination unit 62, and a temperature control unit 64. The temperature acquisition unit 52, the estimation unit 54, the statistical processing unit 56, the target deterioration rate determination unit 58, the temperature control necessity determination unit 60, the target temperature determination unit 62, and the temperature control unit 64 are realized by the above-described processing circuit. For example, a program stored in the storage unit 48 is executed by the processor of the computation unit 50, thereby implementing the temperature acquisition unit 52, the estimation unit 54, the statistical processing unit 56, the target deterioration rate determination unit 58, the temperature control necessity determination unit 60, the target temperature determination unit 62, and the temperature control unit 64. At least one of the IC and the discrete device described above may realize at least a part of the temperature acquisition unit 52, the estimation unit 54, the statistical processing unit 56, the target deterioration rate determination unit 58, the temperature control necessity determination unit 60, the target temperature determination unit 62, and the temperature control unit 64.

The temperature acquisition unit 52 acquires temperature information based on the detection signal of the temperature sensor 24. For example, the temperature acquisition unit 52 acquires gas temperature information based on the detection signal of the gas temperature sensor 24A. The gas temperature information is temperature information indicating the temperature Tcg of the cathode gas introduced into the fuel cell unit 18. The temperature acquisition unit 52 acquires FC temperature information based on the detection signal of the FC temperature sensor 24B. The FC temperature information is temperature information indicating the temperature of the fuel cell unit 18. The temperature acquisition unit 52 acquires the gas temperature information and the FC temperature information from each of the plurality of power generation systems 14.

The estimation unit 54 executes a deterioration rate estimation process. The deterioration rate estimation process is a process of deriving an estimated deterioration rate Des of the fuel cell unit 18 based on the gas temperature information. The estimated deterioration rate Des is an estimated value of the deterioration rate of the fuel cell unit 18. More specifically, the estimated deterioration rate Des is an estimated value of the deterioration rate (stress amount) of the electrolyte membrane provided in the fuel cell unit 18. Since each of the plurality of power generation systems 14 contains the fuel cell unit 18, the fuel cell system 12 as a whole has a plurality of the fuel cell units 18. The estimation unit 54 derives the estimated deterioration rate Des of each of the plurality of fuel cell units 18. Regarding the deterioration rate estimation process, the estimation unit 54 includes a humidity estimation unit 541 and a deterioration rate estimation unit 542, which will be described next.

The humidity estimation unit 541 executes a first estimation process. The first estimation process is a process of estimating the relative humidity RHcg of the cathode gas at the stage of reaching the fuel cell unit 18, based on the temperature Tcg of the cathode gas and the temperature Tfc of the fuel cell unit 18. The relative humidity RHcg is a ratio of the amount of water vapor contained in the cathode gas (i.e., the water vapor content of the cathode gas) to the amount of saturated water vapor in the cathode gas. The temperature Tcg of the cathode gas in this case is specified based on the above-described gas temperature information. The temperature Tfc of the fuel cell unit 18 in this case is specified based on the FC temperature information described above.

The humidity estimation unit 541 may estimate the relative humidity RHcg of the cathode gas using a humidifier model and a relative humidity estimation model which are prepared in advance. The humidifier model is a model (mathematical model) for estimating the water vapor content Wcg of the cathode gas after being humidified by the humidifier 38, based on the temperature Tcg of the cathode gas. The relative humidity estimation model is a model (mathematical model) for estimating the relative humidity RHcg described above, based on the water vapor content Wcg of the cathode gas and the temperature Tfc of the fuel cell unit 18. Each of the humidifier model and the relative humidity estimation model may be a statistical model or a trained machine learning model.

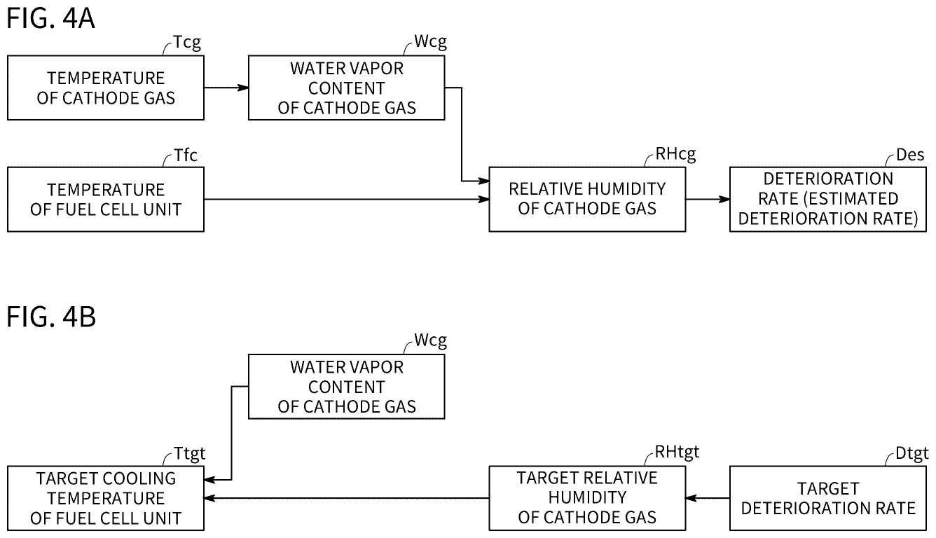

FIG. 4A is a causal relation diagram showing causal relations between the temperature Tcg of cathode gas supplied to the fuel cell unit 18, the water vapor content Wcg of the cathode gas, the temperature Tfc of the fuel cell unit 18, the relative humidity RHcg of the cathode gas, and the deterioration rate (estimated deterioration rate Des) of the fuel cell unit 18.

The change in the temperature Tcg of the cathode gas introduced into the humidifier 38 affects the water vapor content Wcg of the cathode gas after passing through the humidifier 38. Based on this causal relationship, the humidifier model described above is constructed. The amount of saturated water vapor in the cathode gas at the stage of reaching the fuel cell unit 18 changes according to the temperature of the cathode gas at that stage. The temperature varies depending on the temperature Tfc of the fuel cell unit 18. The relative humidity RHcg changes as the amount of saturated water vapor changes. Considering the above, a causal relationship is found between changes in the temperature Tfc of the fuel cell unit 18 and the water vapor content Wcg of the cathode gas, and a change in the relative humidity RHcg at the stage of reaching the fuel cell unit 18. Based on this causal relationship, the relative humidity estimation model is constructed.

The input data of the humidifier model may further include design information of the humidifier 38. The design information of the humidifier 38 includes, for example, one or more parameters indicating characteristics of components (a porous hollow fiber membrane, a module casing, an inner pipe, and the like) included in the humidifier 38. Thus, the water vapor content Wcg of the cathode gas is more favorably estimated by the humidifier model. As a result, the humidity estimation unit 541 can estimate the relative humidity RHcg of the cathode gas more favorably.

The input data of the humidifier model may further include information indicating the pressure, the flow rate, and the like of the cathode gas. The pressure, the flow rate, and the like of the cathode gas can be detected by the above-described pressure sensor, flow rate sensor, and the like. There is a case where the pressure, the flow rate, and the like of the cathode gas may be already set (already known) as control parameters used to control power generation by the fuel cell unit 18. In this case, the humidity estimation unit 541 may add those control parameters to the input data of the humidifier model.

The deterioration rate estimation unit 542 executes a second estimation process. The second estimation process is a process of estimating the estimated deterioration rate Des of the fuel cell unit 18 (electrolyte membrane) described above, based on the relative humidity RHcg of the cathode gas. The relative humidity RHcg of the cathode gas in this case is indicated by the result of estimation by the humidity estimation unit 541. The deterioration rate estimation unit 542 may estimate the estimated deterioration rate Des of the fuel cell unit 18 using a deterioration rate estimation model prepared in advance. The deterioration rate estimation model is a model (mathematical model) that outputs an estimated deterioration rate Des according to input data including information indicating the relative humidity RHcg of the cathode gas. The deterioration rate estimation model may be a statistical model or a trained machine learning model. The input data of the deterioration rate estimation model may further include information (data) other than the information indicating the relative humidity RHcg of the cathode gas.

The lower the relative humidity RHcg of the cathode gas supplied to the fuel cell unit 18, the lower the chemical stability of the electrolyte membrane provided in the fuel cell unit 18. Therefore, the lower the relative humidity RHcg of the cathode gas, the further the deterioration of the fuel cell unit 18 is promoted. That is, there is a causal relationship between the relative humidity RHcg of the cathode gas and the deterioration rate of the fuel cell unit 18, that is, a change in the relative humidity RHcg of the cathode gas affects a change in the deterioration rate of the fuel cell unit 18 (see FIG. 4A). The above-described deterioration rate estimation model is constructed based on this causal relationship.

The statistical processing unit 56 derives a representative value of a plurality of estimated deterioration rates Des estimated for the plurality of fuel cell units 18. The representative value is, for example, an average value of the plurality of estimated deterioration rates Des, but is not limited thereto. For example, the representative value of the plurality of estimated deterioration rates Des may be a median value, a mode value, or the like of the plurality of estimated deterioration rates Des.

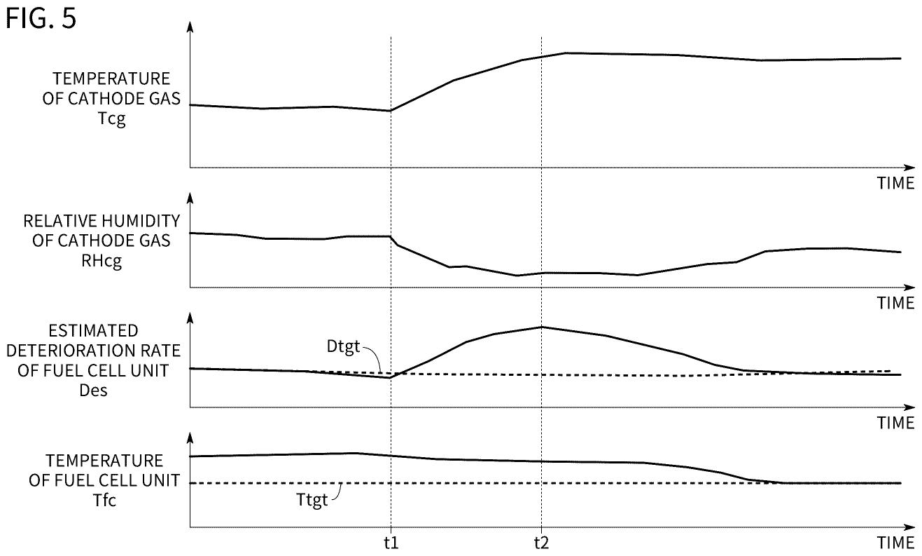

The target deterioration rate determination unit 58 determines a target deterioration rate Dtgt (also refer to FIG. 5), based on the representative value derived by the statistical processing unit 56. The target deterioration rate Dtgt is a target value for the deterioration rate of each of the plurality of fuel cell units 18. The target deterioration rate determination unit 58 may determine one target deterioration rate Dtgt common to the plurality of fuel cell units 18. The target deterioration rate determination unit 58 determines the above-described representative value as the target deterioration rate Dtgt, but the present invention is not limited thereto. For example, the target deterioration rate determination unit 58 may select one estimated deterioration rate Des that is equal to or less than a representative value, from among the plurality of estimated deterioration rates Des, and determine the selected estimated deterioration rate Des as the target deterioration rate Dtgt. When a plurality of estimated deterioration rates Des equal to or less than the representative value are specified, the target deterioration rate determination unit 58 may select one of the plurality of estimated deterioration rates Des equal to or less than the representative value, based on a predetermined selection criterion. The target deterioration rate determination unit 58 may randomly select one of the plurality of estimated deterioration rates Des that are equal to or less than the representative value, or may cause the user of the fuel cell system 12 (vehicle 10) to select one of the plurality of estimated deterioration rates Des.

The temperature control necessity determination unit 60 determines whether or not temperature adjustment control, which will be described later, is necessary for each of the plurality of fuel cell units 18. More specifically, the temperature control necessity determination unit 60 compares the plurality of estimated deterioration rates Des corresponding respectively to the plurality of fuel cell units 18 with the target deterioration rate Dtgt, and specifies the fuel cell unit 18 whose estimated deterioration rate Des is higher than the target deterioration rate Dtgt. The fuel cell unit 18 whose estimated deterioration rate Des is higher than the target deterioration rate Dtgt is determined to be the fuel cell unit 18 that requires the temperature adjustment control described later.

FIG. 4B is a diagram simply illustrating a flow of a target cooling temperature determination process performed by the target temperature determination unit 62.

The target temperature determination unit 62 executes the target cooling temperature determination process based on the target deterioration rate Dtgt and the causal relationship described above. The target cooling temperature determination process is a process for determining a target cooling temperature Ttgt of the fuel cell unit 18 (see also FIG. 5). The target cooling temperature Ttgt of the fuel cell unit 18 is a target temperature for the fuel cell unit 18 that requires temperature adjustment control. Regarding the target cooling temperature determination process, the target temperature determination unit 62 includes a target humidity determination unit 621 and a target cooling temperature determination unit 622, which will be described next.

The target humidity determination unit 621 executes a first determination process included in the target cooling temperature determination process. The first determination process is a process of determining the target relative humidity RHtgt of the cathode gas, based on the target deterioration rate Dtgt. The target relative humidity RHtgt is a target value for the relative humidity RHcg of the cathode gas at the stage of reaching the fuel cell unit 18. As described above, there is a causal relationship between the relative humidity RHcg of the cathode gas and the deterioration rate of the fuel cell unit 18. Based on this causal relationship, the target humidity determination unit 621 specifies the value of the relative humidity RHcg of the cathode gas to be targeted in order to bring the deterioration rate of the fuel cell unit 18 close to the target deterioration rate Dtgt.

The target cooling temperature determination unit 622 executes a second determination process included in the target cooling temperature determination process. The second determination process is a process of determining the target cooling temperature Ttgt, based on the water vapor content Wcg of the cathode gas and the target relative humidity RHtgt. As described above, there is a causal relationship between changes in the temperature Tfc of the fuel cell unit 18 and the water vapor content Wcg of the cathode gas, and a change in the relative humidity RHcg at the stage of reaching the fuel cell unit 18. Based on the causal relationship, the target cooling temperature determination unit 622 specifies the target cooling temperature Ttgt to be targeted in order to bring the relative humidity RHcg of the cathode gas close to the target relative humidity RHtgt.

The target humidity determination unit 621 may achieve the first determination process using a target humidity determination model. The target humidity determination model is a model (mathematical model) that outputs a target relative humidity RHtgt of the cathode gas corresponding to the target deterioration rate Dtgt. The target cooling temperature determination unit 622 may achieve the second determination process using a target cooling temperature determination model. The target cooling temperature determination model is a model (mathematical model) that outputs the target cooling temperature Ttgt according to the water vapor content Wcg of the cathode gas and the target relative humidity RHtgt. Each of the target humidity determination model and the target cooling temperature determination model may be a statistical model or a trained machine learning model.

The temperature control unit 64 executes temperature adjustment control. The temperature adjustment control includes a process in which the temperature control unit 64 controls the temperature adjustment device 22 based on the target cooling temperature Ttgt to lower the temperature of the coolant. The temperature adjustment control may include a process of controlling the coolant pump unit 47 based on the target cooling temperature Ttgt to increase the flow speed of the coolant. This lowers the temperature of the coolant. The temperature adjustment control may include a process of controlling the cooling unit 42 based on the target cooling temperature Ttgt to lower the temperature.

As the temperature of the coolant decreases, the temperature Tfc of the fuel cell unit 18 cooled by that coolant decreases. As the temperature Tfc of the fuel cell unit 18 decreases, the deterioration rate of the fuel cell unit 18 approaches the target deterioration rate Dtgt based on the above causal relationship. The temperature control unit 64 continues the temperature adjustment control until the temperature Tfc of the fuel cell unit 18 determined to require the temperature adjustment control based on the determination result by the temperature control necessity determination unit 60 reaches the target cooling temperature Ttgt of the fuel cell unit 18. When the temperature Tfc of the fuel cell unit 18 reaches the target cooling temperature Ttgt, the temperature control unit 64 ends the temperature adjustment control for the fuel cell unit 18.

FIG. 5 is a diagram schematically showing time-series changes of the temperature Tcg of the cathode gas, the relative humidity RHcg of the cathode gas, the estimated deterioration rate Des of the fuel cell unit 18, and the temperature Tfc of the fuel cell unit 18.

A first time point t1 is shown in FIG. 5. The first time point t1 is a time point at which the temperature Tcg of the cathode gas starts to increase relatively greatly. For example, the temperature Tcg of the cathode gas rises by the cathode gas being heated by a heat source provided in the vehicle 10. The heat source includes, for example, the power generation system 14 included in the fuel cell system 12. For example, when the plurality of power generation systems 14 (141, 142) are arranged in the front-rear direction DFB of the vehicle 10 (also see FIG. 1), exhaust heat of one power generation system 141 located on the front side may heat the cathode gas supplied to another power generation system 142 located on the rear side. As described above, the cathode gas may be taken in from the atmosphere. In this case, the temperature Tcg of the cathode gas may change depending on the external environment of the fuel cell system 12 (vehicle 10).

As the temperature Tcg of the cathode gas rises, the relative humidity RHcg of the cathode gas decreases. As a result, the deterioration rate (estimated deterioration rate Des) of the fuel cell unit 18 increases.

Incidentally, for example, by limiting the operation of the one power generation system 141 described above, the amount of exhaust heat of the one power generation system 141 is reduced. This may lower the temperature Tcg of the cathode gas supplied to the other power generation system 142. However, since the amount of power generation of the entire fuel cell system may be limited, it is not necessarily preferable to limit the operation of each of the plurality of power generation systems 14.

A second time point t2 is also shown in FIG. 5. The second time point t2 is a time point at which the target cooling temperature Ttgt is determined by the target temperature determination unit 62 and the temperature adjustment control by the temperature control unit 64 is started. The temperature Tfc of the fuel cell unit 18 after the second time point t2 is lowered by the temperature adjustment control. This increases the relative humidity RHcg of the cathode gas after the second time point t2, and as a result, the deterioration rate of the fuel cell unit 18 is brought closer to the target deterioration rate Dtgt. By lowering the temperature of the coolant, the temperature Tfc of the fuel cell unit 18 is lowered. As a result, even when the temperature Tcg of the cathode gas is not lowered so much, the relative humidity RHcg of the cathode gas rises, and the deterioration rate of the fuel cell unit 18 is thus suppressed.

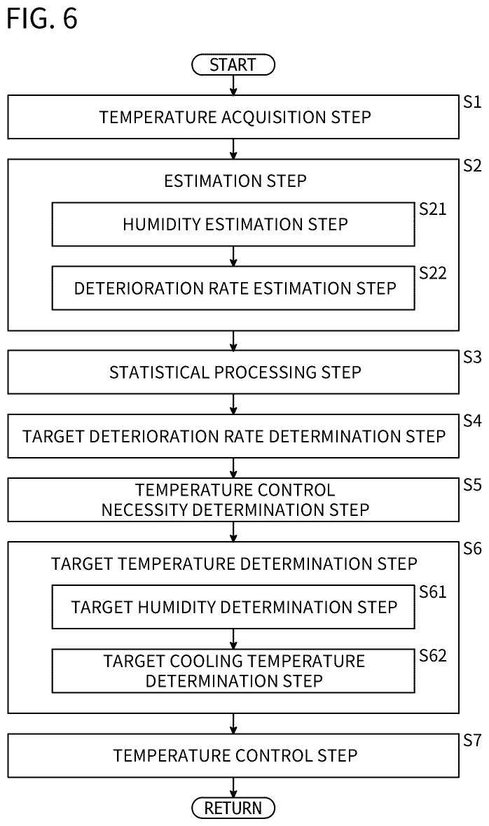

FIG. 6 is a flowchart of a control method according to an embodiment of the present disclosure.

The control device 16 (computer) can execute the control method shown in FIG. 6 based on, for example, the above-described program. The control method of FIG. 6 includes a temperature acquisition step S1, an estimation step S2, a statistical processing step S3, a target deterioration rate determination step S4, a temperature control necessity determination step S5, a target temperature determination step S6, and a temperature control step S7.

In the temperature acquisition step S1, the temperature acquisition unit 52 acquires the gas temperature information and the FC temperature information.

In the estimation step S2, the estimation unit 54 derives the estimated deterioration rate Des of each of the plurality of fuel cell units 18. To be more specific, the estimation step S2 includes a humidity estimation step S21 and a deterioration rate estimation step S22.

In the relative humidity estimation step S21, the relative humidity estimation unit 541 estimates the relative humidity RHcg of the cathode gas, based on the temperature Tcg of the cathode gas supplied to the fuel cell unit 18 and the temperature Tfc of the fuel cell unit 18. The temperature Tcg of the cathode gas is indicated by the temperature information acquired by the temperature acquisition step S1. The temperature Tfc of the fuel cell unit 18 is indicated by the FC temperature information acquired in the temperature acquisition step S1.

In the deterioration rate estimation step S22, the deterioration rate estimation unit 542 estimates the estimated deterioration rate Des, based on the relative humidity RHcg of the cathode gas. The relative humidity RHcg of the cathode gas is indicated by the result of the humidity estimation step S21.

In the statistical processing step S3, the statistical processing unit 56 derives the representative value of the plurality of estimated deterioration rates Des estimated for the respective fuel cell units 18. In the target deterioration rate determination step S4, the target deterioration rate determination unit 58 determines the target deterioration rate Dtgt based on the result of the statistical processing step S3. In the temperature control necessity determination step S5, the temperature control necessity determination unit 60 determines whether or not temperature adjustment control is necessary for each of the plurality of fuel cell units 18.

In the target temperature determination step S6, the target temperature determination unit 62 executes a target cooling temperature determination process. To be more specific, the target temperature determination step S6 includes a target humidity determination step S61 and a target cooling temperature determination step S62.

In the target humidity determination step S61, the target humidity determination unit 621 determines a target relative humidity RHtgt based on the target deterioration rate Dtgt. The target deterioration rate Dtgt in this case is indicated by the result of the target deterioration rate determination step S4.

In the target cooling temperature determination step S62, the target cooling temperature determination unit 622 determines the target cooling temperature Ttgt based on the target relative humidity RHtgt. In the temperature control step S7, the temperature control unit 64 executes temperature adjustment control. The target relative humidity RHtgt in this case is indicated by the result of the target humidity determination step S61. The temperature Tcg of the cathode gas is indicated by the temperature information acquired in the temperature acquisition step S1.

The control device 16, the fuel cell system 12, the vehicle 10, and the control method described above have, for example, the following operational effects.

The control device 16 includes the temperature control unit 64. When the estimated deterioration rate Des is higher than the target deterioration rate Dtgt of the fuel cell unit 18, the temperature control unit 64 controls the cooling unit 42 to lower the temperature Tfc of the fuel cell unit 18. As a result, the relative humidity RHcg of the cathode gas rises, and the deterioration rate of the fuel cell unit 18 approaches the target deterioration rate Dtgt (see also FIG. 5). That is, deterioration of the fuel cell unit 18 is suppressed.

The temperature adjustment control is executed for the fuel cell unit 18 that has the estimated deterioration rate Des higher than the target deterioration rate Dtgt, among the plurality of fuel cell units 18. The temperature control unit 64 performs the temperature adjustment control to bring the deterioration rate of each of the plurality of fuel cell units 18 close to the target deterioration rate Dtgt common to the plurality of fuel cell units 18. This reduces variation in the deterioration rate of the plurality of fuel cell units 18.

The target deterioration rate Dtgt may be determined based on a representative value (average value or the like) of the plurality of estimated deterioration rates Des. This reduces the possibility that an excessively small target deterioration rate Dtgt, an excessively large target deterioration rate Dtgt, or the like is set.

The target temperature determination unit 62 determines the target cooling temperature Ttgt of the fuel cell unit 18 based on the target deterioration rate Dtgt. The temperature control unit 64 lowers the temperature Tfc of the fuel cell unit 18 until the temperature Tfc of the fuel cell unit 18 reaches the target cooling temperature Ttgt. When the temperature Tfc of the fuel cell unit 18 reaches the target cooling temperature Ttgt, the temperature adjustment control for the fuel cell unit 18 is terminated. This prevents an increase in variation in the deterioration rate of the plurality of fuel cell units 18. Further, the fuel cell unit 18 is prevented from being excessively cooled by the temperature adjustment control.

The control device 16 (estimation unit 54) includes the humidity estimation unit 541 and the deterioration rate estimation unit 542. The humidity estimation unit 541 estimates the relative humidity RHcg of the cathode gas supplied to the fuel cell unit 18, based on the temperature Tcg of the cathode gas. Thus, the control device 16 can estimate the estimated deterioration rate Des.

The embodiment may be modified as described below. In the following description, the description overlapping with the embodiment will be omitted as appropriate. The reference numerals assigned to the respective elements for reference to the drawings in the embodiment are also used in the following description unless otherwise specified.

### Modification 1

The deterioration rate estimation model may be a model including the relative humidity estimation model. For example, the deterioration rate estimation model may output the estimated deterioration rate Des according to input data including the gas temperature information and the FC temperature information.

### Modification 2

The humidity estimation unit 541 may estimate the relative humidity RHcg of the cathode gas using a humidity estimation table prepared in advance. The humidity estimation table is a table showing a correspondence relationship between the temperature Tcg of the cathode gas and the relative humidity RHcg. The humidity estimation table is created in advance based on, for example, an experiment, a simulation, or the like.

### Modification 3

The deterioration rate estimation unit 542 may estimate the estimated deterioration rate Des of the electrolyte membrane using a deterioration rate estimation table prepared in advance. The deterioration rate estimation table is a table showing a correspondence relationship between the relative humidity RHcg of the cathode gas and the estimated deterioration rate Des of the fuel cell unit 18. The deterioration rate estimation table is created in advance based on, for example, an experiment, a simulation, or the like.

### Modification 4

The target deterioration rate Dtgt may be a value specified in advance. In this case, the target deterioration rate Dtgt may be optionally specified by a user of the fuel cell system 12 (vehicle 10), or may be specified by a manufacturer that provides the fuel cell system 12 (vehicle 10) to the user.

### Modification 5

The target cooling temperature determination model may be a model including the target humidity determination model. That is, the target cooling temperature determination model may output the target cooling temperature Ttgt according to the target deterioration rate Dtgt. In this case, the target temperature determination unit 62 can achieve the first determination process and the second determination process using the target cooling temperature determination model.

### Modification 6

The target temperature determination unit 62 may achieve the first determination process using a target humidity determination table. The target humidity determination table is a table indicating a correspondence relationship between the target deterioration rate Dtgt and the target relative humidity RHtgt. The target humidity determination table is created in advance based on, for example, an experiment, a simulation, or the like.

### Modification 7

The target temperature determination unit 62 may achieve the second determination process using the target cooling temperature determination table. The target cooling temperature determination table is a table showing a correspondence relationship between the target relative humidity RHtgt and the target cooling temperature Ttgt. The target cooling temperature determination table is created in advance based on, for example, an experiment, a simulation, or the like.

### Modification 8

The gas temperature sensor 24A may sequentially output a detection signal corresponding to the temperature Tcg of the cathode gas. The FC temperature sensor 24B may sequentially output a detection signal corresponding to the temperature of the coolant. In this case, the estimation unit 54 may sequentially derive the estimated deterioration rate Des even while the temperature control step S7 is being executed. The temperature control unit 64 may lower the temperature Tfc of the fuel cell unit 18 until the estimated deterioration rate Des sequentially derived by the estimation unit 54 reaches the target deterioration rate Dtgt. This suppresses deterioration of the fuel cell unit 18.

### Combination of Modifications

The above-described modifications may be combined as appropriate as long as no technical inconsistencies arise.

In relation to the above-described embodiments, the following Supplementary Notes are further disclosed.

### Supplementary Note 1

The control device (16) according to the present disclosure is the control device for a fuel cell system (12), wherein the fuel cell system includes: the fuel cell unit (18), the humidifier (38) that humidifies the cathode gas supplied to the fuel cell unit, and the temperature adjustment device (22) that adjusts the temperature of the fuel cell unit. The control device includes: the estimation unit (54) configured to derive the estimated deterioration rate (Des) of the fuel cell unit, based on the temperature (Tcg) of the cathode gas introduced into the fuel cell unit; and the temperature control unit (64) configured to, in the case that the estimated deterioration rate is higher than the target deterioration rate (Dtgt) of the fuel cell unit, control the temperature adjustment device to lower the temperature of the fuel cell unit. This suppresses deterioration of the fuel cell unit.

### Supplementary Note 2

In the control device according to Supplementary Note 1, the fuel cell system may include the plurality of fuel cell units and the plurality of humidifiers corresponding respectively to the plurality of fuel cell units, and the temperature control unit may lower the temperature of the fuel cell unit that has the estimated deterioration rate higher than the target deterioration rate. This reduces variation in the deterioration rate of the plurality of fuel cell units.

### Supplementary Note 3

The control device according to Supplementary Note 2 may further include the statistical processing unit (56) configured to derive the representative value of the plurality of estimated deterioration rates estimated respectively for the plurality of fuel cell units, and the target deterioration rate may be determined based on the representative value. This reduces the possibility that an excessively small target deterioration rate, an excessively large target deterioration rate, or the like is set.

### Supplementary Note 4

In the control device according to Supplementary Note 3, the representative value may be an average value of the plurality of estimated deterioration rates.

### Supplementary Note 5

In the control device according to Supplementary Note 3, one of the estimated deterioration rates that is equal to or less than the representative value may be determined as the target deterioration rate.

### Supplementary Note 6

In the control device according to Supplementary Note 1 or 2, the target deterioration rate may be a value specified in advance.

### Supplementary Note 7

The control device according to any one of Supplementary Notes 1 to 5 may further include the target temperature determination unit (62) configured to determine the target cooling temperature (Ttgt) of the fuel cell unit, based on the target deterioration rate, wherein in the case that the estimated deterioration rate is higher than the target deterioration rate, the temperature control unit may lower the temperature of the fuel cell unit until the temperature of the fuel cell unit reaches the target cooling temperature. This prevents, for example, an increase in variation in the deterioration rate of the plurality of fuel cell units.

### Supplementary Note 8

In the control device according to any one of Supplementary Notes 1 to 5, the estimation unit may sequentially derive the estimated deterioration rate, and the temperature control unit may lower the temperature of the fuel cell unit until the estimated deterioration rate sequentially derived by the estimation unit reaches the target deterioration rate.

### supplementary Note 9

In the control device according to any one of Supplementary Notes 1 to 8, the estimation unit may include the humidity estimation unit (541) configured to estimate the relative humidity (RHcg) of the cathode gas supplied to the fuel cell unit, based on the temperature of the cathode gas, and the deterioration rate estimation unit (542) configured to estimate the estimated deterioration rate, based on the relative humidity.

### Supplementary Note 10

In the control device according to Supplementary Note 9, the estimated deterioration rate derived by the estimation unit may increase as the relative humidity decreases.

### Supplementary Note 11

In the control device according to any one of Supplementary Notes 1 to 10, the estimated deterioration rate derived by the estimation unit may increase as the temperature of the cathode gas increases.

### Supplementary Note 12

The fuel cell system according to the present disclosure includes the control device according to any one of Supplementary Notes 1 to 11, the fuel cell unit, the humidifier, and the temperature adjustment device.

### Supplementary Note 13

The control method of the present disclosure is the control method of the fuel cell system (12), wherein the fuel cell system includes: the fuel cell unit (18); the humidifier (38) that humidifies the cathode gas supplied to the fuel cell unit; and the temperature adjustment device (22) that adjusts the temperature of the fuel cell unit. The control method includes: the estimation step (S2) of deriving the estimated deterioration rate (Des) of the fuel cell unit, based on the temperature (Tcg) of the cathode gas introduced into the fuel cell unit; and the temperature control step (S7) of, in the case that the estimated deterioration rate is higher than the target deterioration rate (Dtgt) of the fuel cell unit, controlling the temperature adjustment device to lower the temperature of the fuel cell unit.

Although the present disclosure has been described in detail, the present disclosure is not necessarily limited to each of the aforementioned embodiments. In these embodiments, various addition, replacement, changing, partial deletion, and the like can be made without departing from the essence and gist of the present disclosure or without departing from the essence and gist of the present disclosure derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same applies also in the case that numerical values or mathematical equations are used in the description of the aforementioned embodiments.

1. A control device for a fuel cell system, wherein the fuel cell system includes: a fuel cell unit; a humidifier that humidifies a cathode gas supplied to the fuel cell unit; and a temperature adjustment device that adjusts a temperature of the fuel cell unit, the control device comprising:
one or more processors, wherein the one or more processors execute computer-executable instructions stored in a memory to cause the control device to:
derive an estimated deterioration rate of the fuel cell unit, based on a temperature of the cathode gas introduced into the fuel cell unit; and
in a case that the estimated deterioration rate is higher than a target deterioration rate of the fuel cell unit, control the temperature adjustment device to lower the temperature of the fuel cell unit.

2. The control device according to claim 1, wherein
the fuel cell system includes a plurality of the fuel cell units and a plurality of the humidifiers corresponding respectively to the plurality of fuel cell units, and
the one or more processors cause the control device to lower the temperature of the fuel cell unit that has the estimated deterioration rate higher than the target deterioration rate.

3. The control device according to claim 2, wherein
the one or more processors cause the control device to:
derive a representative value of a plurality of the estimated deterioration rates estimated respectively for the plurality of fuel cell units; and
determine the target deterioration rate, based on the representative value.

4. The control device according to claim 3, wherein
the representative value is an average value of the plurality of estimated deterioration rates.

5. The control device according to claim 3, wherein
one of the estimated deterioration rates that is equal to or less than the representative value is determined as the target deterioration rate.

6. The control device according to claim 1, wherein
the target deterioration rate is a value specified in advance.

7. The control device according to claim 1, wherein
the one or more processors cause the control device to:
determine a target cooling temperature of the fuel cell unit, based on the target deterioration rate; and
in the case that the estimated deterioration rate is higher than the target deterioration rate, lower the temperature of the fuel cell unit until the temperature of the fuel cell unit reaches the target cooling temperature.

8. The control device according to claim 1, wherein
the one or more processors cause the control device to:
sequentially derive the estimated deterioration rate; and
lower the temperature of the fuel cell unit until the estimated deterioration rate sequentially derived reaches the target deterioration rate.

9. The control device according to claim 1, wherein
the one or more processors cause the control device to:
estimate a relative humidity of the cathode gas supplied to the fuel cell unit, based on the temperature of the cathode gas; and
estimate the estimated deterioration rate, based on the relative humidity.

10. The control device according to claim 9, wherein
the estimated deterioration rate which is derived increases as the relative humidity decreases.

11. The control device according to claim 1, wherein
the estimated deterioration rate which is derived increases as the temperature of the cathode gas increases.

12. A fuel cell system comprising:
the control device according to claim 1;
the fuel cell unit;
the humidifier; and
the temperature adjustment device.

13. A control method of a fuel cell system, wherein the fuel cell system includes: a fuel cell unit; a humidifier that humidifies a cathode gas supplied to the fuel cell unit; and a temperature adjustment device that adjusts a temperature of the fuel cell unit, the control method being executed by one or more processors, the control method comprising:
deriving an estimated deterioration rate of the fuel cell unit, based on a temperature of the cathode gas introduced into the fuel cell unit; and
in a case that the estimated deterioration rate is higher than a target deterioration rate of the fuel cell unit, controlling the temperature adjustment device to lower the temperature of the fuel cell unit.
